(19) United States
(12) Patent Application Publication
(10) Pub. No.: US 2026/0303653 A1
(43) Pub. Date: Oct. 1, 2026

(54) SYSTEM AND METHODS FOR DETECTION AND MITIGATION OF CLICK-TRIGGERED COMPUTING THREATS

(71) Applicant: Gen Digital Inc., Tempe, AZ (US)

(72) Inventors: Ramalingam Srinivasan, Nolambur (IN); Balu Mohan, Chennai (IN); Iskander Sanchez Rola, Redwood City, CA (US)

(73) Assignee: Gen Digital Inc., Tempe, AZ (US)

(21) Appl. No.: 19/091,221

(22) Filed: Mar. 26, 2025

(51) Int. Cl. H04L 9/40; G06F 3/04842; G06F 21/62

(52) U.S. Cl. CPC H04L 63/1441; G06F 3/04842; G06F 21/629

(57) ABSTRACT

A system for performing a computer-implemented method for preventing malicious network activity is provided. The method includes detecting a first click operation on a first window corresponding to a first uniform resource locator (“URL”), the first window displayed on a graphical user interface (“GUI”) of a computing system. A time of the first click operation is determined. A second click operation is detected on a second window corresponding to a second URL, the second window displayed on the GUI. A time of the second click operation on the second window is detected. The second click operation on the second window is blocked based on the time of the first click operation and the time of the second click operation.

### FIELD OF INVENTION

The disclosure relates generally to computer security, and more particularly to identifying and protecting against computing threats.

### BACKGROUND

Clickjacking is a user interface (UI) redress attack in which a user is tricked into engaging with an element or content displayed in a UI of computer, the function of the element or content being malicious and different than what the user perceived. For example, a popup window displayed in the UI by a malicious application may include text suggesting a beneficial or innocuous function. However, engaging with the popup window via a mouse or touch screen may trigger the downloading via a network of malicious code to the user's computer, authorizing access to sensitive user accounts, or granting permissions to sensitive user information. Preventing such attacks is difficult as a user generally authorizes the action of the malicious application by unwittingly engaging with the element or content generated in the UI of their computer by the malicious application.

### SUMMARY

This Summary introduces simplified concepts that are further described below in the Detailed Description of Illustrative Embodiments. This Summary is not intended to identify key features or essential features of the claimed subject matter and is not intended to be used to limit the scope of the claimed subject matter.

A computer-implemented method of preventing malicious network activity is provided. The method includes detecting a first click operation on a first window corresponding to a first uniform resource locator (“URL”), the first window displayed on a graphical user interface (“GUI”) of a computing system. A time of the first click operation on the first window is determined. A second click operation on a second window corresponding to a second URL is detected, the second window displayed on the GUI, and a time of the second click operation on the second window is determined. The second click operation on the second window is blocked based on the time of the first click operation and the time of the second click operation.

Another computer-implemented method of preventing malicious network activity is provided. The other method includes detecting a first click operation on a first window corresponding to a first URL, the first window displayed on a GUI of a computing system, and determining a location of the first click operation on the GUI. A second click operation on a second window corresponding to a second URL displayed on the GUI is detected, and a location of the second click operation on the GUI is determined. The second click operation on the second window is blocked based on the location of the first click operation and the location of the second click operation.

A further computer-implemented method of preventing malicious network activity is provided. The further method includes detecting a first click operation on a first window displayed on a GUI of a computing system. A time of the first click operation on the first window is determined. A second click operation on a second window displayed on the GUI over the first window is detected, and a time of the second click operation on the second window is determined. The second click operation on the second window is blocked based on the time of the first click operation and the time of the second click operation.

A system is provided including one or more processors and a non-transitory computer readable medium including executable instructions which, when executed by the one or more processors cause the one or more processors to perform operations. The operations include detecting a first click operation on a first window corresponding to a first URL, the first window displayed on a GUI of a computing system, determining a time of the first click operation on the first window, and detecting a second click operation on a second window corresponding to a second URL, the second window displayed on the GUI. The operations further include determining a time of the second click operation on the second window and blocking the second click operation on the second window based on the time of the first click operation and the time of the second click operation.

### BRIEF DESCRIPTION OF THE DRAWINGS

A more detailed understanding may be had from the following description, given by way of example with the accompanying drawings. The Figures in the drawings and the detailed description are examples. The Figures and the detailed description are not to be considered limiting and other examples are possible. Like reference numerals in the Figures indicate like elements wherein:

FIG. 1 shows an environment in which a network-connectable processor-enabled protection manager facilitates assessing network-based threats to a computing device which executes a browser configured to detect and mitigate computing threats.

FIG. 2 shows a hypothetical exemplary computer window flow demonstrating a hypothetical exemplary double-clickjacking process typical of those employed by malicious actors to trick a user into authorizing access to sensitive network-stored data.

FIG. 3 shows a process flow enabled by a browser of the computing device of FIG. 1 for detecting and mitigating a double-clickjacking computing attack.

FIG. 4 shows another hypothetical exemplary computer window flow demonstrating a hypothetical exemplary double-clickjacking process employed by a malicious actor and a mitigating response enabled by a browser according to an illustrative embodiment.

FIGS. 5-7 are diagrams showing methods for detecting and mitigating a double-clickjacking computing attack.

FIG. 8 shows a computer system for performing described methods according to illustrative embodiments.

### DETAILED DESCRIPTION OF ILLUSTRATIVE EMBODIMENTS

Threat actors employ unusual click behavior-based techniques to trick users into performing unintended actions. Double-clickjacking is an emerging user interface (UI) redress attack technique used by malicious actors that exploits a double-click sequence on a computer mouse, touchpad, or touchscreen, to trick users into performing unintended actions, such as downloading via a network malicious code, authorizing access to sensitive user accounts and information, or granting permissions to sensitive user accounts and information. A double-click sequence involves two physical inputs by a computer user of a computer mouse, touchpad, or touchscreen in rapid succession. In normal computer use, double-clicks are used to trigger an action by selecting an icon, button, or other element in the display of a UI using a pointer, as in the case with the mouse or touchpad, or the user's finger, in the case of a touch screen, wherein each of the two clicks of the double-click occurs with the pointer or the user's finger positioned on the display in roughly the same position or in close proximity for each click. Note that “double-clickjacking” differs from “clickjacking.”

A typical double-clickjacking attack pattern involves a target user being lured to double-click on a region of a malicious webpage. When the user performs a double-click operation, the first click triggers a mouse-down event that closes a current window and opens a new window, often an authorization webpage (e.g., an OAuth authorization webpage) including an “authorize” element seeking permission to authorize a malicious application. The authorize element appears in exactly the same region on the browser as the previous region on the malicious webpage where the user first clicked. In such case, the second click of the double-click operation triggers an authorization action, without the user's explicit knowledge. This allows an attacker to complete an authentication process and gain access to sensitive accounts. A double-clickjacking attack pattern may involve other operations like authorizing web3 transactions, disabling a security setting, or downloading malicious code.

Herein described are systems and methods for detecting unusual click behavior by analyzing interaction patterns across domains, considering timing, movement, and contextual cues. The described systems and methods enhance computer security by preventing unintended user actions and defending against attacks such as double-clickjacking.

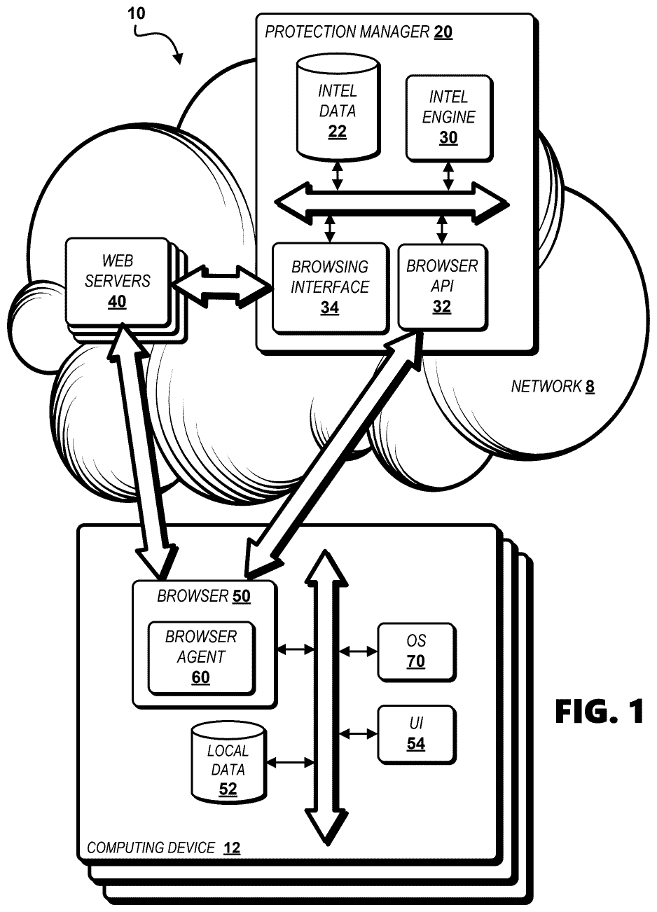

Referring to FIG. 1, an environment 10 enabled by a computer network 8 is illustrated in which a network-connectable processor-enabled protection manager 20 scans networks for the purpose of providing data for detecting threats to computing devices 12. The computer network 8 includes one or more wired or wireless networks or a combination thereof, for example a local area network (LAN), a wide area network (WAN), the internet, mobile telephone networks, and wireless data networks such as Wi-Fi™ and 3G/4G/5G cellular networks. A browser application (“browser”) 50 alone, or in conjunction with a browser agent 60, for example a browser extension, browser integration, or browser plugin, enables monitoring of network browsing activities performed by a user on the browser 50 as executed on a computing device 12. The browser 50 alone or via the browser agent 60 further enables detecting click operations a computer mouse, touchpad, or touchscreen, aggregating the browsing history, logins, and clickstreams of the user on the computing device 12, and storing of aggregated information in a local datastore 52. Monitoring by the browser 50 alone or via the browser agent 60 provides the protection manager 20 with intelligence data including data files and ordered sequences of hyperlinks followed by a user at one or more websites or other network destinations, which data is beneficially received from the browser 50 or the browser agent 60 by the protection manager 20 via a browser application program interface (“API”) 32 and stored in de-identified form in an intelligence datastore 22.

Web servers 40 operated by various entities can enable online services including network-based applications, webpages, or other online services accessible via the browser 50. A user is enabled to engage an online service enabled by a web server 40 for example by registering a user account for which account credentials (e.g., username, password) are created by the user or by an administrator of the service. The protection manager 20 can gather intelligence data in the form of data files, content, and screen captures from web servers 40 via a browsing interface 34, which data is stored in the intelligence datastore 22.

The protection manager 20 coupled to a computing device 12 enables online threat detection and mitigation to be provided to the computing device 12 via the browser 50 alone or via the browser agent 60. The browser 50 alone or via the browser agent 60 monitors user activity on network-based applications and websites enabled by the web servers 40. Monitored data is stored in the local datastore 52 and fed to the protection manager 20 via a browser API 32, which data is stored in the intelligence datastore 22 and used in threat detection and mitigation. The browser API 32 communicates with the browser 50 and the browser agent 60 via the computer network 8. Alternatively, the protection manager 20 can be provided as an application on the computing device 12, for example as an integration or extension to the browser 50, and the browser 50 and the browser agent 60 can communicate locally with the protection manager 20 via the browser API 32 on the computing device 12.

The browser 50 alone or via the browser agent 60 gathers user actions including logins, browsing history, and clickstreams from the browser 50, which data is transmitted to the protection manager 20 via the browser API 32 and stored in the intelligence datastore 22. Based on data received from computing devices 12 via the browser 50 or the browser agent 60, the protection manager via 20 an intelligence engine 30 generates threat information including identifications of potentially malicious applications and website domains. The protection manager 20 provides the threat information to the browser 50 and the browser agent 60 via the browser API 32 for enabling the browser 50 or the browser agent 60 to provide notifications to a user and to filter and block network-based threats confronted by a browser 50, which threat information can be stored in the local datastore 52. The browser 50 alone or via the browser agent 60 provides notices regarding threats to a user via a user interface 54 which includes a graphical user interface (“GUI”).

An operating system 70 (hereinafter “OS 70”) is executed on the computing device 12 which enables integration of the browser agent 60 and the browser 50. The browser 50 and the browser agent 60 are beneficially provided on a plurality of computing devices 12 of a plurality of users allowing aggregation by the protection manager 20 of de-identified data from the plurality of computing devices 12. The browser 50, alone or via the browser agent 60, is configured to mitigate the risk of a double-clickjacking attack.

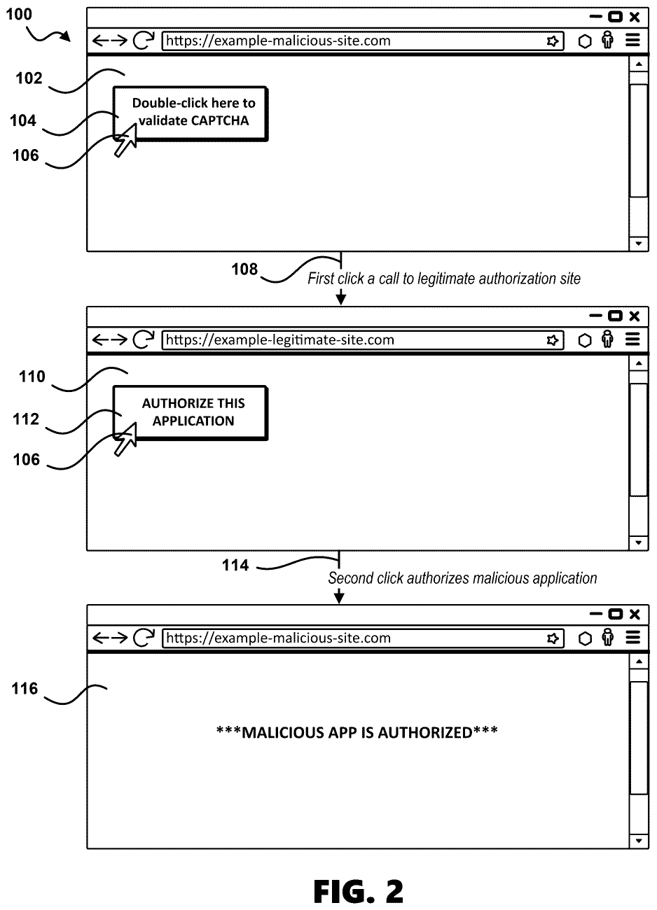

Referring to FIG. 2, a hypothetical exemplary computer window flow 100 is shown demonstrating a hypothetical exemplary double-clickjacking process typical of those employed by malicious actors to trick a user into authorizing access to sensitive network-stored data (e.g., financial account information, social media account information, messaging account information). In response to a hypothetical user's browsing, a webpage browser window 102 is opened in the graphical user interface (“GUI”) of the user's computing device. The webpage browser window 102 presents a malicious website enabled by a network-hosted malicious application corresponding to the uniform resource locator (“URL”) “example-malicious-site.com” which includes a button 104 with the label “Double-click here to validate CAPTCHA”. The user, thinking they are performing an innocuous human verification process, double-clicks with their mouse or other computer input device on the button 104 with a pointer 106. The first click (step 108) initiates a call to a legitimate authorization service (e.g., an OAuth authorization service) at the URL “example-legitimate-site.com”, generating the webpage browser window 110 over the webpage browser window 102.

The authorization service includes for example an authorization service for an online social media, email, messaging, or banking platform. The browser window 110 includes a button 112 with the label “AUTHORIZE THIS APPLICATION” positioned in the same location on the GUI as the button 104 of the browser window 102. As a result, the second click (step 114) occurs with the pointer 106 over the button 112 initiating an authorization via the authorization service at example-legitimate-site. com. Responsive to clicking the button 112, the authorization service transfers the user back to the malicious website at example-malicious-site.com and provides the malicious application a token authorizing access to the user's data on a platform which the authorization service is associated with (e.g., a social media, email, messaging, or banking platform). The malicious application provides a notification “***MALICIOUS APP IS AUTHORIZED***” in the browser window 116 after receiving the token, and the malicious application is free to access the user's data on the platform using the token. In practice, an application with malicious intent may not provide any such notification to a user.

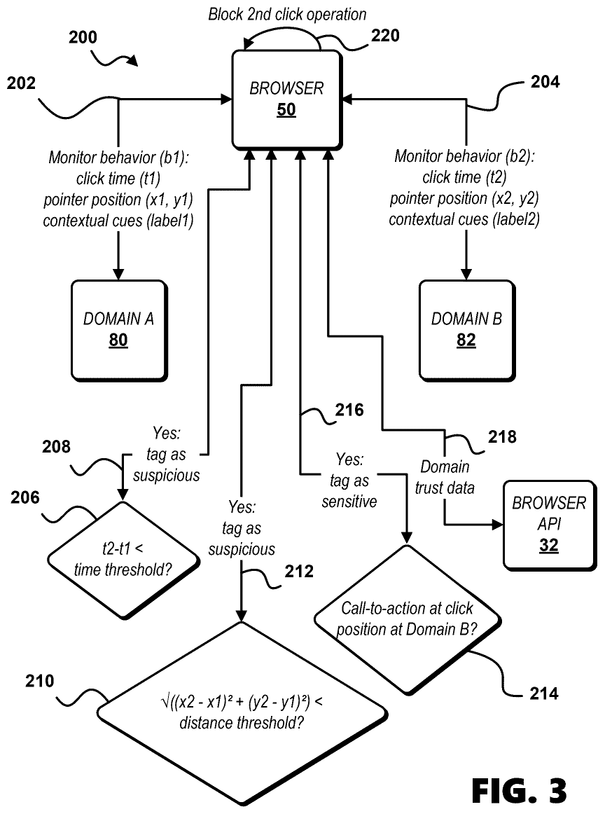

Referring to FIG. 3, a process flow 200 illustrates operations performed in real-time by a processor of the computing device 12 via the browser 50, alone or in conjunction with the browser agent 60, to prevent a double-clickjacking attack from compromising the computing device 12 or the data of a user of the computing device 12. The browser 50, as executed by the processor of the computing device 12, alone or in conjunction with the browser agent 60, monitors behavior of a user including the interactions of the user with elements in the browser 50 as displayed via the user interface 54 including a GUI. In a process step 202, the browser 50 via the processor of the computing device 12 monitors behavior (“b1”) occurring during an interaction with a first resource (e.g., a first webpage) corresponding to a first domain (“domain A”) 80. The monitored behavior b1 includes one or more of the time of a first click operation (“t1”) on the first resource, a pointer position in two-dimensional space on the GUI (“x1, y1”) at the time of the click operation on the first resource, or one or more contextual cues, such as a label on a button on the first resource on which the click operation is performed (“label1”). In a process step 204, after the process step 202, the browser 50 via the processor of the computing device 12 monitors behaviors (“b2”) occurring during an interaction with a second resource (e.g., a second webpage or an overlay) corresponding to a second domain (“domain B”) 82. Monitored behavior b2 includes one or more of the time of a second click operation (“t2”) on the second resource, a pointer position in two-dimensional space on the GUI (“x2, y2”) at the time of the click operation on the second resource, or one or more contextual cues, such as a label on a button on the second resource on which the second click operation is performed (“label2”). The browser 50, alone or via the browser agent 60, as executed by the processor of the computing device 12 analyzes monitored behavior b2 and monitored behavior b1 in real-time to determine unusual or abnormal click operations.

In a first determination process enabled by the process flow 200, the browser 50 measures the time between first and second click operations (step 206). When the user of the browser 50 clicks on the first resource (e.g., a first webpage) corresponding to the first domain A 80, the browser 50 records the time t1. When the user of the browser 50 thereafter clicks on the second resource (e.g., a second webpage or overlay) corresponding to the second domain B 82, the browser 50 records the time t2. The browser 50 determines the difference between t2 and t1 (t2−t1) to determine the time taken to click between the two resources (e.g., two webpages) corresponding to the two domains A and B 80, 82. The browser 50 beneficially determines the two resources corresponding to the two domains A and B 80, 82 are consecutively clicked. If the determined time difference is less than a particular time threshold, for example 500 ms, 1000 ms, or the double-click threshold set in settings of the operating system 70, the browser 50 tags the clicks as suspicious (step 208).

In a second determination process enabled by the process flow 200, the browser 50 measures the distance between pointer positions at two click operations, the pointer positions controlled by the user for example by a computer mouse, touchpad, or touchscreen of the UI 54 of the computing device 12. When the user of the browser 50 clicks on the first resource (e.g., a first webpage) corresponding to the first domain A 80, the browser 50 captures the first pointer position (x1, y1) of the click, for example by implementing a click event listener coded in JavaScript™ as “const coordinatesDomainA={x:event. clientX, y:event. clientY};” to determine the first pointer position (x1, y1) in screen pixels. When the user of the browser 50 thereafter clicks on the second resource (e.g., a second webpage or overlay) corresponding to the second domain B 82, the browser 50 captures the second pointer position (x2, y2) of the click, for example by implementing a click event listener coded in JavaScript™ as “const coordinatesDomainB ={x: event.clientX, y: event.clientY};” to determine the second pointer position (x2, y2) in screen pixels. If the measured pointer click positions (x1, y1) and (x2, y2) fall within a particular proximity, the browser 50 tags the clicks as suspicious. The browser 50 determines the distance between the first pointer position (x1, y1) and the second pointer position (x2, y2) to determine the proximity of the click positions (step 210), for example by the expression \sqrt{(x2−x1)²+(y2−y1)²} to determine the distance in screen pixels. If the determined distance is less than a particular distance threshold, the browser 50 tags the clicks as suspicious (step 212). The particular distance threshold is beneficially less than 30 pixels.

In a third determination process enabled by the process flow 200, the browser 50 detects a context switch from the first domain A 80 to the second domain B 82, the context switch for example including a switch from the first resource (e.g., a first webpage) corresponding to the first domain A 80 to the second resource (e.g., a second webpage or overlay) corresponding to the second domain B 82. Responsive to the context switch, the browser 50 captures content (e.g., webpage body text or label text) read at the click position on the second resource corresponding to the second domain B 82 and analyzes captured content to determine a confirmation action, an authorization action, or other call-to-action (“CTA”) (step 214). Captured content that includes for example “authorize” text can indicate the allowing of application permissions on an OAuth page. Particularly, a confirmation action or an authorization action suggested by “authorize” text can for example suggest that the second resource corresponding to the second domain B 82 is an OAuth webpage configured to grant application permissions to an application hosted on the first domain A 80. The browser 50 captures content (e.g., webpage body text or label text) detected at the click position on the second resource corresponding to the second domain B 82 for example by implementing JavaScript™ coding instructions “event.target.innerText” or “event.target.textContent”. If there is a context change and a confirmation action, authorization action or other call-to-action, the browser 50 tags the clicks as potentially “sensitive” actions affecting sensitive user data (step 216) or tags the clicks as “suspicious.” Alternatively or additionally, the browser compares (e.g., using a topic classifier) the content of the first resource to the content of the second resource and tags the clicks as a potentially “sensitive” actions or as “suspicious” based on the comparison, for example based on determined subject matter of the content of the first resource and the second resource being unrelated or incompatible.

The first and second determination processes and corresponding suspicious tagging operations in steps 208 and 212 can for example individually or in conjunction indicate suspicious activity. The suspicious tagging operations in steps 208 and 212 in conjunction with a sensitive tagging operation in step 216 can for example indicate a confirmed malicious action. The browser 50 blocks the second click operation of the second click (step 220), for example blocking actuation of an element such as a button of the second resource or blocking a triggered action resulting from the actuation of an element such as a button, responsive to determining suspicious activity in one or both of steps 208 and 212. Alternatively, the browser 50 blocks the second click operation of the second click responsive to determining suspicious activity in one or both of steps 208 and 212 and determining a potentially sensitive activity affecting sensitive user data in step 216. Further, the browser 50 or the browser agent 60 receives data related to trustability of domains via the browser API 32 (step 218) for example based on intelligence received from other computing devices 12, and in an alternative implementation the browser 50 blocks the second click operation of the second click further based on the trustability of the first domain A, the second domain B, or both the first domain A and the second domain B. A benefit of the process flow 200 is that the computing resources to perform the determinations in steps 206, 210, and 214 to trigger the blocking of the click operation (step 220) are low, and therefore the determinations are performed in real-time without deleteriously affecting the user experience.

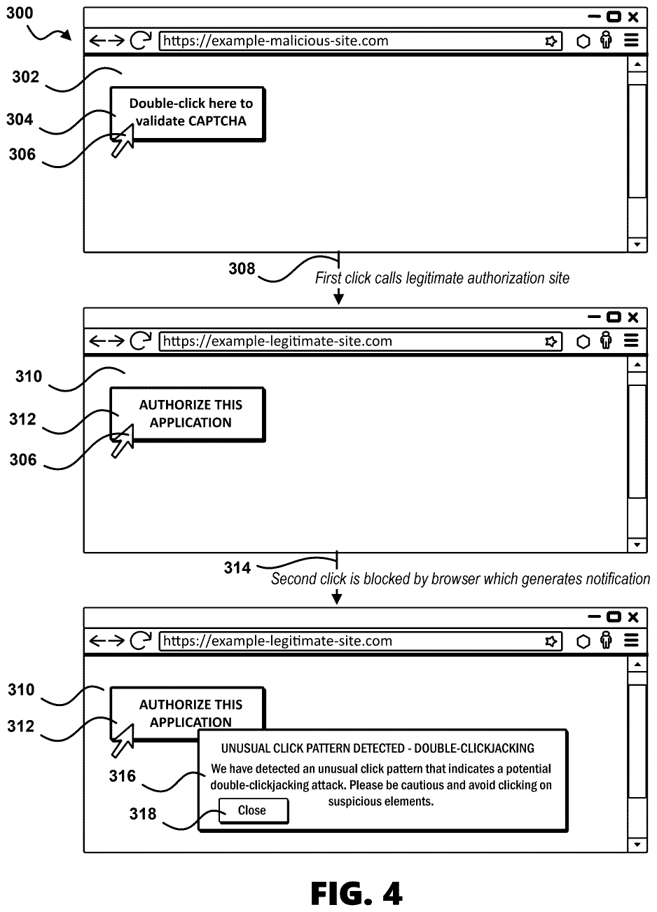

Referring to FIG. 4, a hypothetical exemplary computer window flow 300 is shown demonstrating a hypothetical exemplary double-clickjacking process employed by a malicious actor to trick a user into authorizing access to sensitive network-stored data (e.g., financial account information, social media account information, messaging account information) and a mitigating response enabled by the browser 50 alone or in combination with the browser agent 60 as executed by a processor on the computing device 12. In response to a hypothetical user's browsing using the browser 50, a first webpage browser window 302 is opened in the graphical user interface (“GUI”) of the user interface 54 of the user's computing device 12. The first webpage browser window 302 presents a webpage enabled by a network-hosted malicious application corresponding to the uniform resource locator (“URL”) “example-malicious-site.com” which includes a button 304 with the label “Double-click here to validate CAPTCHA.” The user of the browser 50 of computing device 12, thinking they are performing an innocuous human verification process, double-clicks with their mouse or other computer input device on the button 304 with a pointer 306. The first click (step 308) initiates a call to a legitimate authorization service (e.g., an OAuth authorization service) at “example-legitimate-site.com” generating a second webpage browser window 310 over the first webpage browser window 302.

The authorization service includes for example an authorization service for an online social media, email, messaging, or banking platform. The second webpage browser window 310 includes an authorization button 312 with the label “AUTHORIZE THIS APPLICATION” positioned in the same location on the GUI as the button 304. As a result, the second click (step 314) occurs with the pointer 306 over the authorization button 312 signaling the browser 50 to actuate the authorization button 312 which would initiate an authorization via the authorization service at example-legitimate-site.com. Notwithstanding, responsive to clicking the authorization button 312, the browser 50 via a processor of the computing device 12 performs the first, second, and third determination processes (steps 206, 210, and 214) of the process flow 200 in real-time and blocks actuation of the authorization button 312 (step 314) in real-time based on suspicious determinations in steps 208 and 212 and a sensitive determination in step 216. The browser 50 further launches a notification window 316 over the browser window 310 indicating “UNUSUAL CLICK PATTERN DETECTED—DOUBLE—CLICKJACKING” and “We have detected an unusual click pattern that indicates a potential double-clickjacking attack. Please be cautious and avoid clicking on suspicious elements.” A user is enabled to close the notification window 316 by clicking a close button 318, after which the user is enabled to re-click the authorization button 312 if they desire to authorize the application originating at “example-malicious-site.com”, which re-click operation is not blocked by the browser 50.

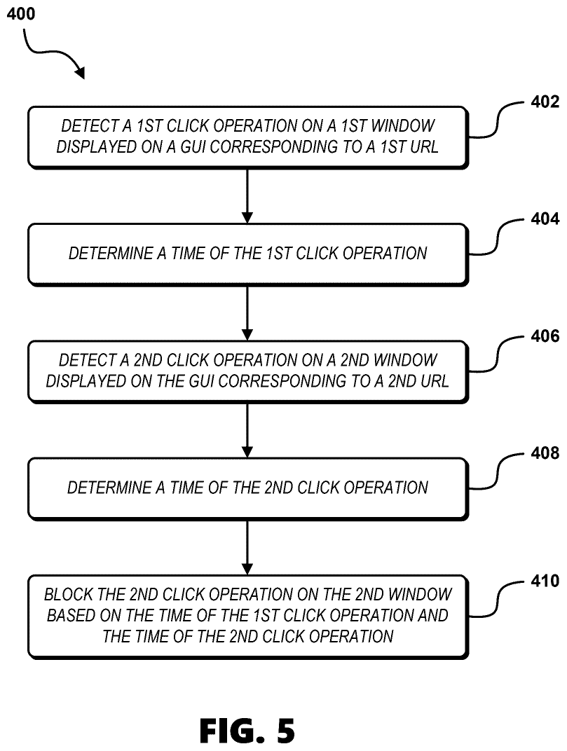

Referring to FIG. 5, a computer-implemented method 400 of preventing malicious network activity is shown. The method 400 is described with reference to the components of the environment 10 including the protection manager 20, the web servers 40, and the computing devices 12 including the browser 50 and the browser agent 60. Alternatively, the method 400 can be performed via other systems and is not restricted to being implemented by the described components.

The method 400 includes detecting a first click operation on a first window corresponding to a first uniform resource locator (“first URL”), the first window displayed on a graphical user interface (“GUI”) of a computing system (step 402). A time of the first click operation on the first window is determined (step 404). A second click operation on a second window corresponding to a second uniform resource locator (“second URL”) is detected, the second window displayed on the GUI (step 406), and a time of the second click operation on the second window is determined (step 408). The second click operation on the second window is blocked based on the time of the first click operation and the time of the second click operation (step 410). Beneficially, a difference is determined between the time of the first click operation and the time of the second click operation, wherein the blocking of the second click operation is based on the difference between the time of the first click operation and the time of the second click operation.

In a particular implementation of the method 400, a location of the first click operation on the first window on the GUI is determined, a location of the second click operation on the second window on the GUI is determined, and the second click operation on the second window is blocked further based the location of the first click operation and the location of the second click operation. Beneficially, a distance between the location of the first click operation and the location of the second click operation is determined, and the blocking of the second click operation on the second window is further based the distance between the location of the first click operation and the location of the second click operation.

In another implementation of the method 400, detecting the first click operation on the first window includes detecting the first click operation on a first webpage associated with a first domain, and detecting the second click operation on the second window includes detecting the second click operation on a second webpage associated with a second domain. Alternatively, detecting the first click operation on the first window includes detecting the first click operation on a webpage associated with a first domain, and detecting the second click operation on the second window includes detecting the second click operation on an overlay over the webpage, the overlay associated with a second domain. Alternatively, detecting the first click operation includes detecting an interaction with an element of the first window, detecting the second click operation includes detecting an interaction with an element of the second window, and blocking the second click operation on the second window includes blocking actuation of the element of the second window. In a particular implementation, detecting the first click operation includes detecting an interaction with an element of the first window comprising a first call-to-action, detecting the second click operation includes detecting an interaction with an element of the second window comprising a second call-to-action, and blocking the second click operation on the second window includes blocking actuation of the element of the second window comprising the second call-to-action. The element of the first window includes for example a first button, the element of the second window includes for example a second button, and blocking the second click operation on the second window includes for example blocking actuation of the second button. Alternatively or additionally, blocking the second click operation includes one or more of blocking authorization of a transaction, blocking downloading a file by the computing system, or blocking executing a file by the computing system, for example a file including a computer virus. In another implementation of the method 400 content of the first window is detected, content of the second window is detected, the content of the first window and the content of the second window are compared, and the second click operation on the second window is blocked further based on the comparing the content of the first window and the content of the second window.

In another implementation of the method 400 a change of context in the GUI is detected, and blocking the second click operation is further based on the change of context in the GUI. Beneficially, the change of context includes the second window opening on top of the first window in the GUI. A location of the second click operation on the GUI is determined responsive to the detecting the change of context in the GUI, and content (e.g., label text) is detected in the second window based on the location of the second click operation responsive to the detecting the change of context in the GUI. It is determined that the content detected in the second window indicates one or more of a call-to-action, a confirmation, or an authorization, and the second click operation is blocked further based on the determining that the content detected in the second window indicates the one or more of the call-to-action, the confirmation, or the authorization.

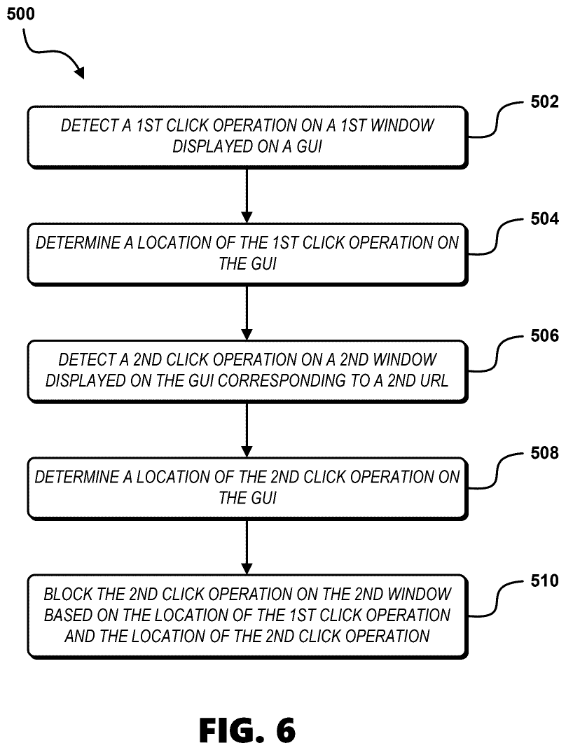

Referring to FIG. 6, a computer-implemented method 500 of preventing malicious network activity is shown. The method 500 is described with reference to the components of the environment 10 including the protection manager 20, the web servers 40, and the computing devices 12 including the browser 50 and the browser agent 60. Alternatively, the method 500 can be performed via other systems and is not restricted to being implemented by the described components.

The method 500 includes detecting a first click operation on a first window corresponding to a first uniform resource locator (“first URL”), the first window displayed on a graphical user interface (“GUI”) of a computing system (step 502). A location of the first click operation on the GUI is determined (step 504). A second click operation on a second window corresponding to a second uniform resource locator (“second URL”) displayed on the GUI is detected (step 506), and a location of the second click operation on the GUI is determined (step 508). The second click operation on the second window is blocked based on the location of the first click operation and the location of the second click operation (step 510).

In a particular implementation of the method 500 a change of context in the GUI is detected and blocking the second click operation is further based on the change of context in the GUI. For example, the change of context includes the second window opening on top of the first window in the GUI. Content (e.g., label text) is detected in the second window based on the location of the second click operation responsive to the detecting the change of context in the GUI. It is determined that the content of the second window indicates one or more of a call-to-action, a confirmation, or an authorization, and the second click operation is blocked further based on the determining that the content of the second window indicates the one or more of the call-to-action, the confirmation, or the authorization.

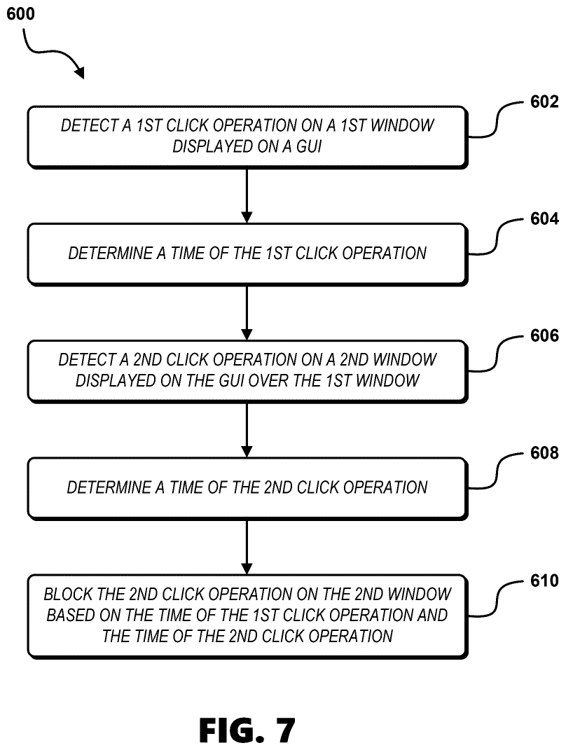

Referring to FIG. 7, a computer-implemented method 600 of preventing malicious network activity is shown. The method 600 is described with reference to the components of the environment 10 including the protection manager 20, the web servers 40, and the computing devices 12 including the browser 50 and the browser agent 60. Alternatively, the method 600 can be performed via other systems and is not restricted to being implemented by the described components.

The method 600 includes detecting a first click operation on a first window displayed on a graphical user interface (“GUI”) of a computing system (step 602). A time of the first click operation on the first window is determined (step 604). A second click operation on a second window displayed on the GUI over the first window is detected (step 606), and a time of the second click operation on the second window is determined (step 608). The second click operation on the second window is blocked based on the time of the first click operation and the time of the second click operation (step 610). Beneficially, a difference is determined between the time of the first click operation and the time of the second click operation, wherein the blocking of the second click operation is based on the difference between the time of the first click operation and the time of the second click operation.

In a particular implementation of the method 600, a location of the first click operation on the first window on the GUI is determined, a location of the second click operation on the second window on the GUI is determined, and the second click operation on the second window is blocked further based the location of the first click operation and the location of the second click operation. Beneficially, a distance between the location of the first click operation and the location of the second click operation is determined, and the blocking of the second click operation on the second window is further based the distance between the location of the first click operation and the location of the second click operation. Beneficially, the blocking the second click operation on the second window includes one or more of blocking authorization of a transaction, blocking disabling or enabling of a setting on the computing system, blocking downloading a file by the computing system, or blocking executing a file by the computing system.

The methods 400, 500, and 600 and are implementable by one or more systems including one or more processors and a non-transitory computer readable medium including executable instructions which, when executed by the one or more processors cause the one or processors to perform operations described with reference to the methods 400, 500, and 600.

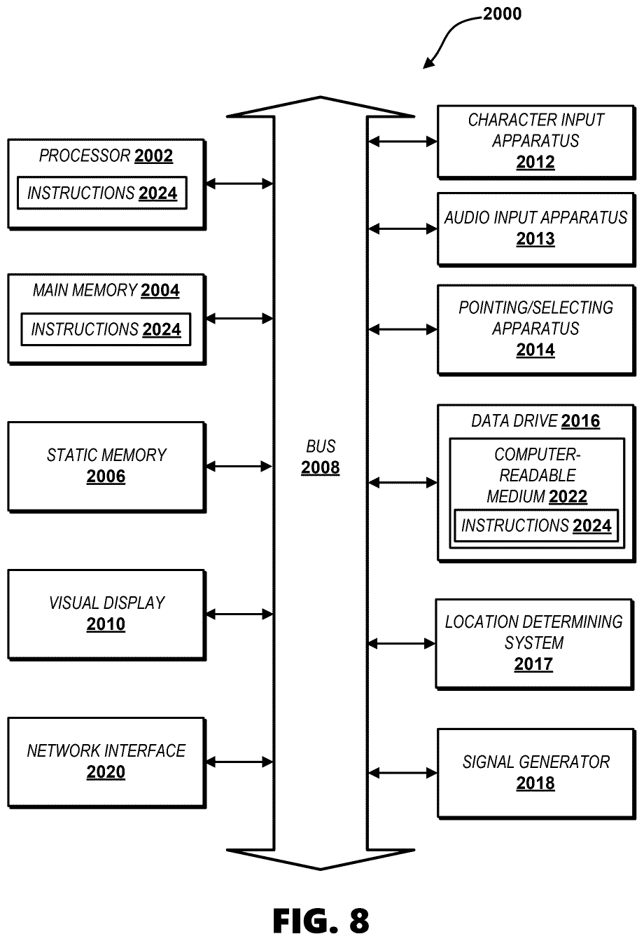

FIG. 8 illustrates in abstract the function of an exemplary computer system 2000 on which the systems, methods and processes described herein can execute. For example, the computing device 12 and the protection manager 20 can each be embodied by a particular computer system 2000 or a plurality of computer systems 2000. The computer system 2000 may be provided in the form of a personal computer, laptop, handheld mobile communication device, mainframe, distributed computing system, or other suitable configuration. Illustrative subject matter is in some instances described herein as computer-executable instructions, for example in the form of program modules, which program modules can include programs, routines, objects, data structures, components, or architecture configured to perform particular tasks or implement particular abstract data types. The computer-executable instructions are represented for example by instructions 2024 executable by the computer system 2000.

The computer system 2000 can operate as a standalone device or can be connected (e.g., networked) to other machines. In a networked deployment, the computer system 2000 may operate in the capacity of a server or a client machine in server-client network environment, or as a peer machine in a peer-to-peer (or distributed) network environment. The computer system 2000 can also be considered to include a collection of machines that individually or jointly execute a set (or multiple sets) of instructions to perform one or more of the methodologies described herein, for example in a cloud computing environment.

It would be understood by those skilled in the art that other computer systems including but not limited to networkable personal computers, minicomputers, mainframe computers, handheld mobile communication devices, multiprocessor systems, microprocessor-based or programmable electronics, and smart phones could be used to enable the systems, methods and processes described herein. Such computer systems can moreover be configured as distributed computer environments where program modules are enabled and tasks are performed by processing devices linked through a computer network, and in which program modules can be located in both local and remote memory storage devices.

The exemplary computer system 2000 includes a processor 2002, for example a central processing unit (CPU) or a graphics processing unit (GPU), a main memory 2004, and a static memory 2006 in communication via a bus 2008. A visual display 2010 for example a liquid crystal display (LCD), a light emitting diode (LED) display, or a cathode ray tube (CRT) is provided for displaying data to a user of the computer system 2000. The visual display 2010 can be enabled to receive data input from a user for example via a resistive or capacitive touch screen. A character input apparatus 2012 can be provided for example in the form of a physical keyboard, or alternatively, a program module which enables a user-interactive simulated keyboard on the visual display 2010 and actuatable for example using a resistive or capacitive touchscreen or touchpad. An audio input apparatus 2013, for example a microphone, enables audible language input which can be converted to textual input by the processor 2002 via the instructions 2024. A pointing/selecting apparatus 2014 can be provided, for example in the form of a computer mouse or enabled via a resistive or capacitive touch screen or touchpad in the visual display 2010. A data drive 2016, a signal generator 2018 such as an audio speaker, and a network interface 2020 can also be provided. A location determining system 2017 is also provided which can include for example a GPS receiver and supporting hardware.

The instructions 2024 and data structures embodying or used by the herein-described systems, methods, and processes, for example software instructions, are stored on a computer-readable medium 2022 and are accessible via the data drive 2016. Further, the instructions 2024 can completely or partially reside for a particular time period in the main memory 2004 or within the processor 2002 when the instructions 2024 are executed. The main memory 2004 and the processor 2002 are also as such considered computer-readable media.

While the computer-readable medium 2022 is shown as a single medium, the computer-readable medium 2022 can be considered to include a single medium or multiple media, for example in a centralized or distributed database, or associated caches and servers, that store the instructions 2024. The computer-readable medium 2022 can be considered to include any tangible medium that can store, encode, or carry instructions for execution by a machine and that cause the machine to perform any one or more of the methodologies described herein, or that can store, encode, or carry data structures used by or associated with such instructions. Further, the term “computer-readable storage medium” can be considered to include, but is not limited to, solid-state memories and optical and magnetic media that can store information in a non-transitory manner. Computer-readable media can for example include non-volatile memory such as semiconductor memory devices (e.g., magnetic disks such as internal hard disks and removable disks, magneto-optical disks, CD-ROM and DVD-ROM disks, Erasable Programmable Read-Only Memory (EPROM), Electrically Erasable Programmable Read-Only Memory (EEPROM), and flash memory devices).

The instructions 2024 can be transmitted or received over a computer network, for example the computer network 8, using a computer-readable signal transmission medium via the network interface 2020 operating under one or more known transfer protocols, for example FTP, HTTP, or HTTPs. Examples of computer networks include a local area network (LAN), a wide area network (WAN), the internet, mobile telephone networks, Plain Old Telephone (POTS) networks, and wireless data networks, for example Wi-Fi™ and 3G/4G/5G cellular networks. The term “computer-readable signal transmission medium” can be considered to include any transitory intangible medium that is capable of storing, encoding, or carrying instructions for execution by a machine, and includes digital or analog communications signals or other intangible medium to facilitate communication of such instructions.

Although features and elements are described above in particular combinations, one of ordinary skill in the art will appreciate that each feature or element can be used alone or in any combination with the other features and elements. Methods described herein may be implemented in a computer program, software, or firmware incorporated in a computer-readable medium for execution by a computer or processor.

While embodiments have been described in detail above, these embodiments are non-limiting and should be considered as merely exemplary. Modifications and extensions may be developed, and all such modifications are deemed to be within the scope defined by the appended claims.

What is claimed is:

1. A computer-implemented method comprising:
detecting a first click operation on a first window corresponding to a first uniform resource locator (“URL”), the first window displayed on a graphical user interface (“GUI”) of a computing system;
determining a time of the first click operation on the first window;
detecting a second click operation on a second window corresponding to a second URL, the second window displayed on the GUI;
determining a time of the second click operation on the second window; and
blocking the second click operation on the second window based on the time of the first click operation and the time of the second click operation.

2. The method of claim 1, further comprising:
determining a location of the first click operation on the first window on the GUI;
determining a location of the second click operation on the second window on the GUI; and
blocking the second click operation on the second window further based the location of the first click operation and the location of the second click operation.

3. The method of claim 1, further comprising:
determining a location of the first click operation on the first window on the GUI;
determining a location of the second click operation on the second window on the GUI;
determining a distance between the location of the first click operation and the location of the second click operation; and
blocking the second click operation on the second window further based the distance between the location of the first click operation and the location of the second click operation.

4. The method of claim 1, further comprising determining a difference between the time of the first click operation and the time of the second click operation, wherein the blocking the second click operation is based on the difference between the time of the first click operation and the time of the second click operation.

5. The method of claim 1, further comprising determining a difference between the time of the first click operation and the time of the second click operation is less than a threshold time, wherein the blocking the second click operation is based on the determining the difference between the time of the first click operation and the time of the second click operation is less than the threshold time.

6. The method of claim 1, wherein:
detecting the first click operation on the first window comprises detecting the first click operation on a first webpage associated with a first domain; and
detecting the second click operation on the second window comprises detecting the second click operation on a second webpage associated with a second domain.

7. The method of claim 1, wherein:
detecting the first click operation on the first window comprises detecting the first click operation on a webpage associated with a first domain; and
detecting the second click operation on the second window comprises detecting the second click operation on an overlay over the webpage, the overlay associated with a second domain.

8. The method of claim 1, further comprising:
detecting content of the first window;
detecting content of the second window;
comparing the content of the first window and the content of the second window; and
blocking the second click operation on the second window further based on the comparing the content of the first window and the content of the second window.

9. The method of claim 1, wherein:
detecting the first click operation comprises detecting an interaction with an element of the first window;
detecting the second click operation comprises detecting an interaction with an element of the second window; and
blocking the second click operation on the second window comprises blocking actuation of the element of the second window.

10. The method of claim 1, further comprising:
detecting a change of context in the GUI; and
blocking the second click operation further based on the change of context in the GUI.

11. The method of claim 1, further comprising:
detecting a change of context in the GUI, the change of context comprising the second window opening on top of the first window in the GUI;
determining a location of the second click operation on the GUI responsive to the detecting the change of context in the GUI;
detecting content of the second window based on the location of the second click operation responsive to the detecting the change of context in the GUI;
determining the content of the second window indicates at least one of a call-to-action, a confirmation, or an authorization; and
blocking the second click operation further based on the determining the content of the second window indicates the at least one of the call-to-action, the confirmation, or the authorization.

12. The method of claim 11, wherein the content of the second window comprises label text.

13. The method of claim 1, wherein:
detecting the first click operation comprises detecting an interaction with an element of the first window, the element of the first window comprising a first button;
detecting the second click operation comprises detecting an interaction with an element of the second window, the element of the second window comprising a second button; and
blocking the second click operation on the second window comprises blocking actuation of the second button.

14. The method of claim 1, wherein:
detecting the first click operation comprises detecting an interaction with an element of the first window, the element of the first window comprising a first call-to-action;
detecting the second click operation comprises detecting an interaction with an element of the second window, the element of the second window comprising a second call-to-action; and
blocking the second click operation on the second window comprises blocking actuation of the element of the second window.

15. The method of claim 1, wherein the blocking the second click operation on the second window comprises at least one of blocking authorization of a transaction, blocking downloading a file by the computing system or blocking executing a file by the computing system.

16. A computer-implemented method comprising:
detecting a first click operation on a first window corresponding to a first URL, the first window displayed on a graphical user interface (“GUI”) of a computing system;
determining a location of the first click operation on the GUI;
detecting a second click operation on a second window corresponding to a second URL, the second window displayed on the GUI;
determining a location of the second click operation on the GUI; and
blocking the second click operation on the second window based on the location of the first click operation and the location of the second click operation.

17. The method of claim 16, further comprising:
detecting a change of context in the GUI; and
blocking the second click operation further based on the change of context in the GUI.

18. The method of claim 16, further comprising:
detecting a change of context in the GUI, the change of context comprising the second window opening on top of the first window in the GUI;
detecting content of the second window based on the location of the second click operation responsive to the detecting the change of context in the GUI;
determining that the content indicates at least one of a call-to-action, a confirmation, or an authorization; and
blocking the second click operation further based on the determining that the content indicates the at least one of the call-to-action, the confirmation, or the authorization.

19. A computer-implemented method comprising:
detecting a first click operation on a first window displayed on a graphical user interface (“GUI”) of a computing system;
determining a time of the first click operation on the first window;
detecting a second click operation on a second window over the first window, the second window displayed on the GUI;
determining a time of the second click operation on the second window; and
blocking the second click operation on the second window based on the time of the first click operation and the time of the second click operation.

20. The method of claim 19, further comprising:
determining a location of the first click operation on the first window on the GUI;
determining a location of the second click operation on the second window on the GUI; and
blocking the second click operation on the second window further based the location of the first click operation and the location of the second click operation.

21. The method of claim 19, wherein the blocking the second click operation on the second window comprises at least one of blocking authorization of a transaction, blocking disabling or enabling of a setting on the computing system, blocking downloading a file by the computing system, or blocking executing a file by the computing system.

22. A system comprising:
at least one processor; and
a non-transitory computer readable medium including executable instructions which, when executed by the at least one processor cause the at least one processor to perform operations comprising:
detecting a first click operation on a first window corresponding to a first URL, the first window displayed on a graphical user interface (“GUI”) of a computing system;
determining a time of the first click operation on the first window;
detecting a second click operation on a second window corresponding to a second URL, the second window displayed on the GUI;
determining a time of the second click operation on the second window; and
blocking the second click operation on the second window based on the time of the first click operation and the time of the second click operation.

23. The system of claim 22, the executable instructions, when executed by the at least one processor, further cause the system to perform operations comprising:
determining a location of the first click operation on the GUI;
determining a location of the second click operation on the GUI;
determining a distance between the location of the first click operation and the location of the second click operation; and
blocking the second click operation on the second window further based the distance between the location of the first click operation and the location of the second click operation.

24. The system of claim 22, the executable instructions, when executed by the at least one processor, further cause the system to perform operations comprising:
detecting the second window opening on top of the first window in the GUI;
determining a location of the second click operation;
detecting content of the second window based on the location of the second click operation responsive to the detecting the second window opening on top of the first window in the GUI;
determining the content indicates at least one of a call-to-action, a confirmation, or an authorization; and
blocking the second click operation further based on the determining the content indicates the at least one of the call-to-action, the confirmation, or the authorization.

25. A non-transitory computer readable medium having instructions which, when executed by at least one processor of a computing device, cause the computing device to perform operations comprising:
detecting a first click operation on a first window corresponding to a first URL, the first window displayed on a graphical user interface (“GUI”) of a computing system;
determining a time of the first click operation on the first window;
detecting a second click operation on a second window corresponding to a second URL, the second window displayed on the GUI;
determining a time of the second click operation on the second window; and
blocking the second click operation on the second window based on the time of the first click operation and the time of the second click operation.

26. The non-transitory computer readable medium of claim 25, the executable instructions, when executed by the at least one processor, further cause the computing device to perform operations comprising:
detecting the first click operation on a webpage associated with a first domain; and
detecting the second click operation on an overlay over the webpage, the overlay associated with a second domain.

27. The non-transitory computer readable medium of claim 25, the executable instructions, when executed by the at least one processor, further cause the computing device to perform operations comprising:
determining a location of the first click operation on the GUI;
determining a location of the second click operation on the GUI; and
blocking the second click operation on the second window further based on the location of the first click operation and the location of the second click operation.
